(19) United States
(12) Patent Application Publication
(10) Pub. No.: US 2022/0230134 A1
(43) Pub. Date: Jul. 21, 2022

(54) CENTRALIZED PRINTING APPLICATION FOR PROVENANCE OF ASSETS

(71) Applicant: Avery Dennison Retail Information Services LLC, Mentor, OH (US)

(72) Inventors: Linwood PURSELL, Bellbrook, OH (US); Jeanne DUCKETT, Franklin, OH (US)

(21) Appl. No.: 17/612,499

(22) PCT Filed: Jun. 15, 2020
(86) PCT No.: PCT/US2020/037753

§ 371 Date: Nov. 18, 2021

Related U.S. Application Data
(60) Provisional application No. 62/862,175, filed on Jun. 17, 2019.

(51) Int. Cl. G06Q 10/08; G06K 19/06

(52) U.S. Cl. CPC G06Q 10/0833; G06K 19/06037; G06Q 10/087

(57) ABSTRACT

The present invention relates to a centralized system for generating labels and/or RFID tags that are printed and/or encoded with standard schema to make tracking of components easier in order to provide for the provenance of assets, especially consumable goods. A smart printing terminal is provided that can manage the product commissioning process as each item or component for a particular product is readied for shipment. The entire case, as well as pallet information, may be correlated together to provide for a complete data set relating to the products commissioned for a particular grower/producer or end user/customer.

### CROSS-REFERENCE TO RELATED APPLICATIONS

This application claims the benefit of U.S. Application No. 62/862,175, filed Jun. 17, 2019, the entire disclosure of which is incorporated herein by reference.

### FIELD

The invention relates to the use of a centralized system for transparency programs and, more particularly, to the provenance of food and other consumable products to provide for a secure chain from grower or producer to end user or consumer.

### BACKGROUND

Businesses have often struggled with the practice of tracing products from their point of origin all the way to retail. The inability of businesses to do this may lead to significant cost expenditures, particularly when some sort of problem is identified with a small number of products, which forces the business to issue a massive recall or freeze sales until all noncomplying products can be taken off the shelves.

Some of the best examples of this come from the field of food safety. The Food Safety Modernization Act of 2011 (“FMSA”) Section 204 High Risk Foods requires the U.S. Food and Drug Administration (“FDA”) to define protocols to compel business to implement electronic traceability. This is similar to the U.S. Drug Supply Chain Act of 2013 where item level pharmaceuticals have a phase-in schedule for complete electronic traceability and the Fighting Illicit Trade in the European Union for tobacco products. The FSMA initially received the one step back and one step up guidance from the Bioterrorism Act of 2002. However, in the years since the passage of the Bioterrorism Act, the one step back, one step up approach has been deemed not viable from a timeliness standpoint. The high profile spinach recall of 2006 where 200 people fell ill, 31 people experienced organ failure and three people died resulted in forming the Produce Traceability Initiative in 2007. When the FDA announces their plans for implementation of Section 204 of the FSMA it is anticipated that they will have a phase-in plan for very large-, large- and medium-sized business. Many believe there will be more changes in food production systems in the next ten years than there have been in the past fifty years. Products will be reformulated; new food sources and production approaches will be realized, and the food system will become increasingly digitalized. Food safety professionals and companies must adapt to the changing world around us to protect public health and facilitate innovation. Smarter food safety is not a slogan or a tagline. It is a new approach to food safety, a new mindset, one that recognizes and builds on the progress made in the past but incorporates the use of new technologies that are being used in society and business sectors all around us, such as blockchain, sensor technology, the Internet-of-Things (“IoT”), and Artificial Intelligence (“AI”).

The reason why it took so long to identify the source of the contaminated products was due to the complicated supply chain process managed by a network of growers, wholesalers, distributors and retailers, almost none of whom had information about their entire supply chain at hand. Electronic data generally only makes it one or two steps downstream; a retailer might know who their distributor is, the distributor might know the identity of its source, and that source may have its own source, all of which generally must be identified manually. With large retailers having an extremely high number of products and locations (for example, major retailers have over 50,000 products on the shelves at their multi-thousand store locations, sourced from thousands of vendors) tracking products can become a nightmare. As such, even highly sophisticated retailers can take around a week to identify the origin of a product even under the most-dire circumstances.

Additionally, as grocery stores and other food providers are increasingly going digital with respect to their shipping, receiving, and inventory, there are related complexities associated with supply chains, store formats, and shopping strategies. Consumers are demanding more information related to food products and more visibility with respect to food products on sale and consumed. Further, there are increasing demands and requirements regarding food safety and food waste.

Visibility and transparency is not limited to retail food products and can include not only fast casual, quick service restaurants (QSR), but also the ranchers and growers of the food. There is an increasing desire to show consumers the name, location, and plot of the farm where the salad was grown to demonstrate its local or organic status. Ranchers want to provide the origin of where the cattle, chickens, pigs, goats, bison, ostrich, etc. are raised or produced in order to demand or justify the premium prices they are seeking.

Food is not the only product that businesses may need to trace to its point of origin. Another example of a business with such a need is vehicle operators, particularly the airline industry. If a vehicle has some kind of catastrophic failure, such as a turbine explosion in an airplane, it can be extremely important to identify the point of origin for the component so that, if the part failed due to some sort of manufacturing defect, any other similar components can be identified and taken out of their respective vehicles. This can also be an issue with many other types of machine parts, from consumer goods to industrial equipment, though vehicles have some of the highest risks of catastrophic failure leading to significant loss of life. Such components can otherwise be extremely difficult to identify and source; often, individual components may not be separately marked with identifying information, and, often, manufacturers of each successive component in a chain (for example, an individual fan blade, the other components of a turbine assembly, an engine, and an aircraft as a whole may all have different manufacturers) may not have information on the sources of each other component in their assembled products. As a result, attribution of fault after an accident is made much more difficult. Likewise, the procedures that must be undertaken in order to ensure the safety of such components are made much more complex and expensive than they might otherwise have to be without information sharing.

Finally, it may also be important to other parties other than businesses where their products come from. Customers, with good reason, may have greater peace of mind if they can guarantee that the products they have purchased are not subject to recall anywhere, and have been safely vetted at every individual stage of the process. This has become an issue of increasing concern for customers due to the high number of counterfeit or poor-quality goods, which have caused a large number of health scares. For example, in one year, one toy maker had to recall nearly one million toys due to lead paint being used in certain factories, toy train manufacturer had to recall 1.5 million toys for the same reason, half a million radial tires were recalled by distributor after a safety feature was unilaterally eliminated by the factory, and—in a scandal that attracted the much news—a children's craft product contained a toxic contaminant that hospitalized a number of children. As such, many customers are clamoring for a way to guarantee that the products they purchase are authentic and free of such unexpected complications.

Customers also have an interest in “ethical sourcing” of products or “sustainable manufacturing techniques” being used in their production; this has typically amounted to customers having a slight preference for “ethical” or “sustainable” products which can result in some degree of brand loyalty toward companies that can guarantee that they are engaging in sustainable practices and ethical sourcing. Better tracking of products from point of origin to retail can guarantee this for the customer.

Methods of creating a chain of custody have evolved over the last 20 years, including the formation of supplier industry groups to create agreement on what data each supply chain partner needs to collect and share. The Global Dialogue on Seafood Traceability or Produce Traceability Initiative is a recent example, but there are examples in the aerospace industry that date back to the late 1990s. Many agree that it is good idea to have full supply chain traceability for supply chain optimization, provenance, food/pharmaceutical safety, and consumer trust; and they have agreed upon it for at least 20 years. The question is why does it not exist. The answer rests in both complexity and amount of labor. As can be appreciated, there is a need for systems and methods for full supply chain traceability. The invention is directed to these, as well as other, important needs.

### BRIEF SUMMARY

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention provides a centralized system for generating barcode labels and/or RFID tags that are printed and/or encoded with standard schema to make application and tracking of components easier in order to provide for the provenance of the goods (or assets or products, used interchangeably herein). A smart printing terminal is provided, which can manage the product commissioning process as each item for a particular product is readied for shipment. Then the entire case information, as well as the pallet containing the cases, can all be correlated together to provide for a complete data set relating to the goods/assets/products commissioned from a particular grower/producer or for end user/customer. The key to this process is that the key data elements for the critical tracking events defined by the Global Traceability Specifications are seamlessly created and captured in the background without any additional effort by the operator.

In one exemplary embodiment, a system for providing consumable product traceability and transparency is provided and includes a centralized printing hub having a printer for printing and encoding labels; at least one consumable product; a database connected to the hub for receiving data provided to the hub; and a label for using in tracking and identifying the at least one consumable product.

Accordingly, in one embodiment, the invention is directed to systems for asset traceability and transparency, comprising:
a centralized printing hub having a printer for printing and encoding labels;
at least one asset to be traced;
packaging for the at least one asset;
a machine-readable label for use in tracking and identifying each of the at least one asset;
   wherein the machine-readable label is generated by the hub and applied to the packaging; and
   wherein the machine-readable label comprises a serialized digital identity associated with each of the at least one asset;
a database connected to the hub for receiving inputs provided to the hub to form commissioning information;
   wherein the inputs comprise:
      the serialized digital identity associated with each of the at least one asset; and
      item instance data associated with each of the at least one asset; and
an interface to exchange the commissioning information associated with the packaging with a distributed storage system;
   wherein the commissioning information is sent via an EPCIS XML or JSON data file.

In other embodiments, the invention is directed to methods of tracing assets, comprising:
providing a machine-readable label for packaging for at least one asset;
   wherein the machine-readable label comprises a serialized digital identity associated with each of the at least one asset; and
extracting the data from the packaging to create an EPCIS XML or JSON data file;
transmitting the EPCIS XML or JSON data file to an external application to commission the asset into a distributed storage system to trace the asset.

Other features and advantages of the present invention will become apparent to those skilled in the art from the following detailed description. It is to be understood, however, that the detailed description of the various embodiments and specific examples, while indicating preferred and other embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a label and RFID encoding that aligns with required traceability information where the GTIN, Lot, Expiry Date and Serial Number is on the carton;

FIG. 2A shows two exemplary tags generated in connection with the present invention relating to a traceability case label;

FIG. 2B shows exemplary tags generated in connection with the present invention;

FIG. 3 illustrates a system flow for generating the tag and transferring the data to the data system;

FIG. 4 provides a schematic of the representation of the user interface;

FIG. 5 illustrates an exemplary screen shot for commissioning a shipment;

FIG. 6 shows an exemplary screen shot for commissioning a pallet;

FIG. 7 depicts an exemplary screen shot for commissioning a case;

FIG. 8 is the EPCIS XML or JSON coding for a commissioning event as depicted in FIGS. 5-7;

FIG. 9 is EPCIS XML or JSON coding for a shipping event as depicted in FIGS. 5-7; and

FIG. 10A-10D depict exemplary screen shots for registration with GS1 through a web link to the GS1 Data Hub/Companies.

### DETAILED DESCRIPTION

The apparatuses and methods disclosed in this document are described in detail by way of examples and with reference to the figures. Unless otherwise specified, like numbers in the figures indicate references to the same, similar, or corresponding elements throughout the figures. It will be appreciated that modifications to disclosed and described examples, arrangements, configurations, components, elements, apparatuses, methods, materials, etc. can be made and may be desired for a specific application. In this disclosure, any identification of specific shapes, materials, techniques, arrangements, etc. are either related to a specific example presented or are merely a general description of such a shape, material, technique, arrangement, etc. Identifications of specific details or examples are not intended to be, and should not be, construed as mandatory or limiting unless specifically designated as such. Selected examples of apparatuses and methods are hereinafter disclosed and described in detail with reference made to figures.

The following definitions are used herein to further define and describe the disclosure:

As used herein, the terms “comprises,” “comprising,” “includes,” “including,” “has,” “having” or any other variation thereof, are intended to cover a non-exclusive inclusion. For example, a process, method, article/composition, or apparatus that comprises a list of elements is not necessarily limited to only those elements but may include other elements not expressly listed or inherent to such process, method, article/composition, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

As used herein, the terms “a” and “an” include the concepts of “at least one” and “one or more than one.”

As used herein, the term “commissioning” means the action of associating or linking digital identities that are generated by an application with a physical item. This linkage coincides with standards defined by GS1 (GS1 Electronic Product Code Information Services (EPCIS) standard/Core Business Vocabulary (CBV)), which is incorporated herein by reference. As defined in the CBV, “commissioning” is a process of associating an instance-level identifier (such as an EPC) with a specific object, or the process of associating a class-level identifier, not previously used, with one or more objects. A tag may have been encoded and applied in this step, or may have been previously encoded. In the case of a class-level identifier, commissioning differs from creating_class_instance in that commissioning always indicates that this is the first use of the class-level identifier, whereas creating_class_instance does not specify whether the class-level identifier has been used before.

The present invention is directed in certain embodiments (especially foods, particularly produce) to providing a central printing systems for hosting and producing GS1 compliant item or case labels to be used in the early portion of the food supply chain, or the “first mile” when food has been harvested, undergone some initial processing, and is ready for transport to a distribution center or other outlet. One advantage that this system claims is the ability to field mark field packed produce with a mark that begins the chain of custody. Field packed produce is produce that is placed directly into a sanitary container for direct shipment to retail grocery or food service. These products include but are not limited to melons, gourds, squash, berries, head lettuce, cauliflower, broccoli, cabbage and others. By field marking with an IoT printer not only is the produce identity created and associated with the reusable container or produce bin, the event is created in background without any intervention from the operator. The systems and methods of the invention simplify the commissioning process of creating the digital identities by providing services that include a repository for static information, mathematical procedure to generate, store and maintain unique serial numbers, and a process to combine these data elements with incidental data to produce GS1 complaint information.

The current system reaches back towards the farms or growers within the supply chain to “commission” cases of assets/products/goods, essentially creating their initial digital identity that permits the tracking of the assets/products/goods and allows the relevant data to be placed in a database or cloud platform to provide provenance of the assets/products/goods. This data may include assets/products/goods master data attributes formatted in a standard way stored in the GS1 Data Hub, which will then be accessible by GS1 GDSN data providers or W3C standard semantic web searches. In addition, this system can interface to artificial intelligence (“AI”)-vision devices, enabling the system to automatically generate the product master data. The assets/products/goods master data attributes may include data captured from various sensors, including, but not limited to, weight, temperature, carbon dioxide level, microbial level, humidity level, and the like.

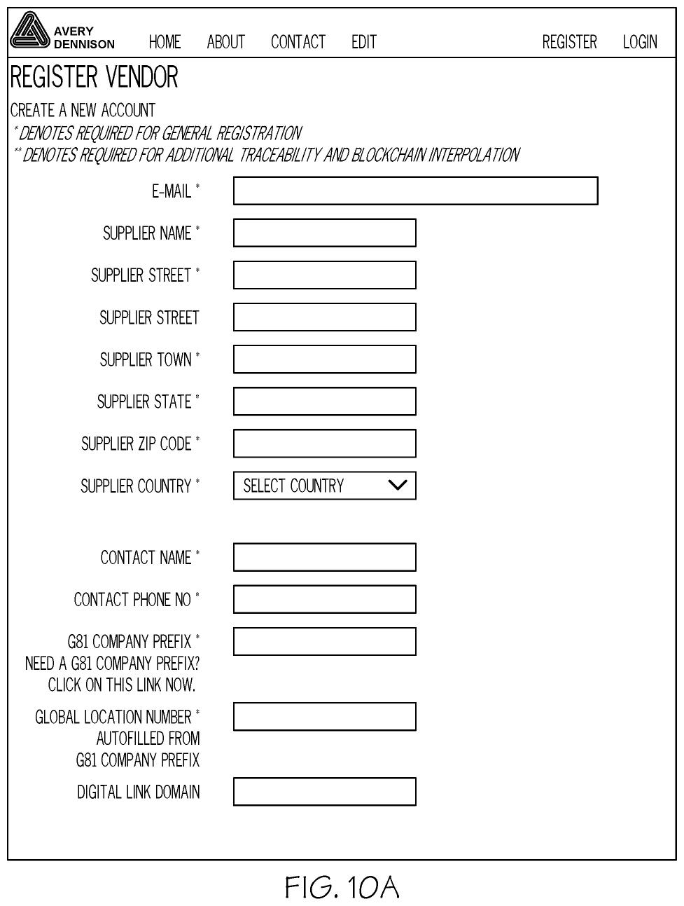

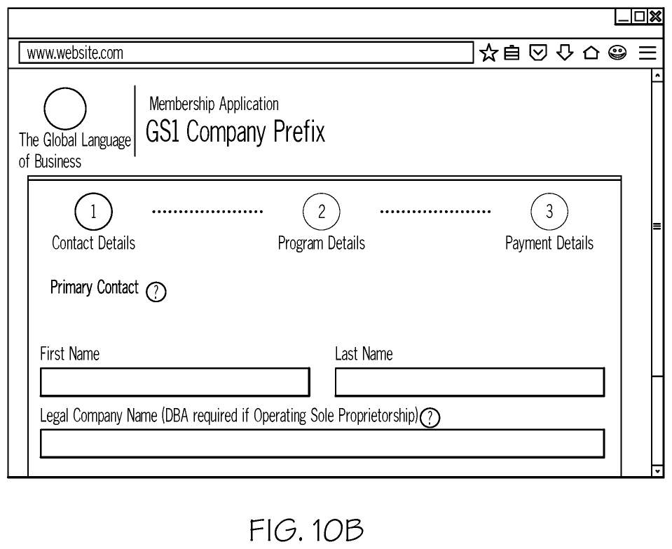

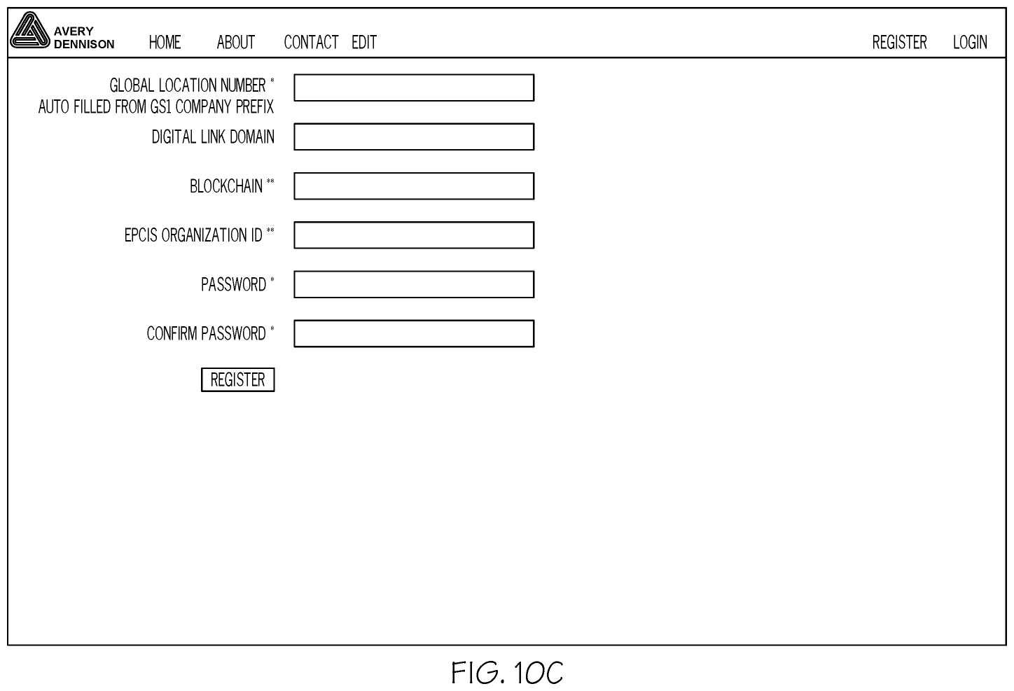

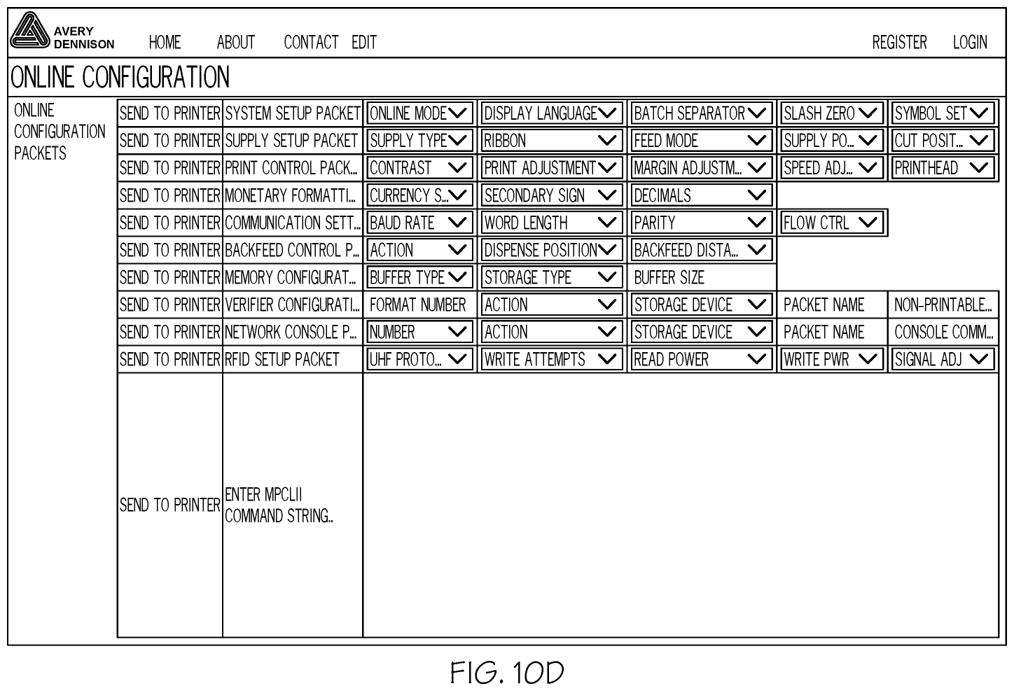

The system of the present invention, in certain embodiments, combines input from the customer along with GS1 data (the customer configures the data based on being a GS1 member) to build the data sets required to produce the labels. The system includes the capability to support registration with GS1 through a web link (such as an Identity Partner link) to the GS1 Data Hub/Companies, as shown in FIGS. 10A-10D. Capabilities include multiple language support, as shown in FIG. 10C, and complete printer configuration and setup for a drop list enabled configurator utility integrated into the application, as shown in FIG. 10B.

In addition, in certain embodiments, the system extracts the data from each case/carton label that is produced (including EPC data used for the RFID inlay) to create an XML or JSON data file to be used to interface to external applications to commission the item into an appropriate distributed storage system such as an immutable ledger (including blockchain, such as, for example, IBM Food Trust, Food Logiq, and the like), client-server or cloud-based system. This data may be either in the form of proprietary data or in an industry standard, such as EPCIS. This data connector relieves the operator from needing to understand the nuances of multiple traceability platforms if he uses more than one distribution channel. This data exchange may be accomplished by integrating the blockchain or other remote system application programming interface (“API”; computing interface defining interactions between multiple software intermediaries) providers supply into the system of the present invention.

Accordingly, in one embodiment, the invention is directed to systems for asset traceability and transparency, comprising:
a centralized printing hub having a printer for printing and encoding labels;
at least one asset to be traced;
packaging for the at least one asset;
a machine-readable label for use in tracking and identifying each of the at least one asset;
   wherein the machine-readable label is generated by the hub and applied to the packaging; and
   wherein the machine-readable label comprises a serialized digital identity associated with each of the at least one asset;
a database connected to the hub for receiving inputs provided to the hub to form commissioning information;
   wherein the inputs comprise:
      the serialized digital identity associated with each of the at least one asset; and
      item instance data associated with each of the at least one asset; and
an interface to exchange the commissioning information associated with the packaging with a distributed storage system;
   wherein the commissioning information is sent via an EPCIS XML or JSON data file.

In other embodiments, the invention is directed to methods of tracing assets, comprising:
providing a machine-readable label for packaging for at least one asset;
   wherein the machine-readable label comprises a serialized digital identity associated with each of the at least one asset; and
extracting the data from the packaging to create an EPCIS XML or JSON data file;
transmitting the EPCIS XML or JSON data file to an external application to commission the asset into a distributed storage system to trace the asset.

In certain embodiments, the systems and methods further comprise a device for reading the machine-readable label. The device captures the serialized digital identification for the asset and the item instance data. The item instance data may include, but is not limited to, device location, user, time, date, asset description, packaging description, season, lot, and expiry.

In certain embodiments, the serialized digital identity is encoded on at least one identifier selected from the group consisting a barcode, a radio-frequency identification (RFID) tag (also referred to as a label or inlay), and a quick response (QR) code.

In certain embodiments, the machine-readable label further comprises a global product attribute.

In certain embodiments, the machine-readable label further comprises sensor data associated with the packaging. The sensor data may include, but is not limited to, at least one parameter selected from the group consisting of weight, temperature, carbon dioxide level, microbial level, and humidity level.

In certain embodiments, the interface is an external programmatic interface or application programming interface.

In certain embodiments, the EPCIS XML or JSON data file comprises EPC data for the machine-readable label.

In certain embodiments, the distributed storage system is an immutable ledger, client server, or cloud-based system.

In certain embodiments, the asset may be, for example, an item selected from the group consisting of a food product, a pharmaceutical product, a vehicle part, a toy, or a baby product.

In certain embodiments, the packaging is a reusable container, carton, case, crate, box, or pallet.

The systems and methods may be used to facilitate an architectural discussion with different solutions providers with the goal of providing provenance of assets in order to comply with a transparency program in an effort to address recalls and other issues.

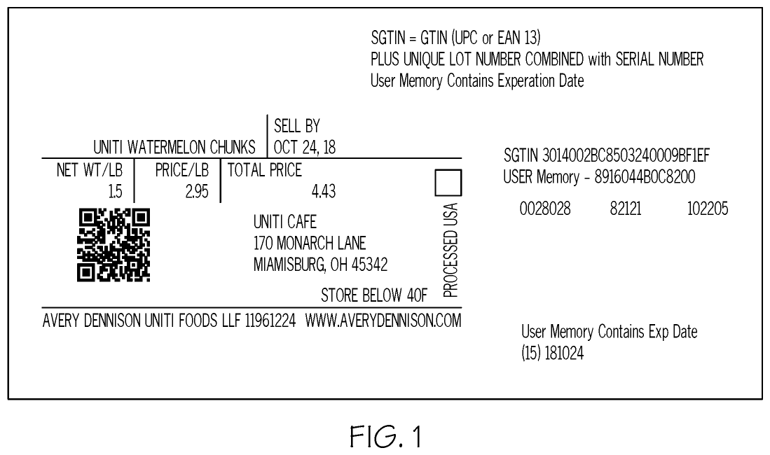

FIG. 1 shows and exemplary encoding schema that can be used in connection with the provenance of assets as contemplated by this invention. The schema is part of a standard promulgated by GS1.

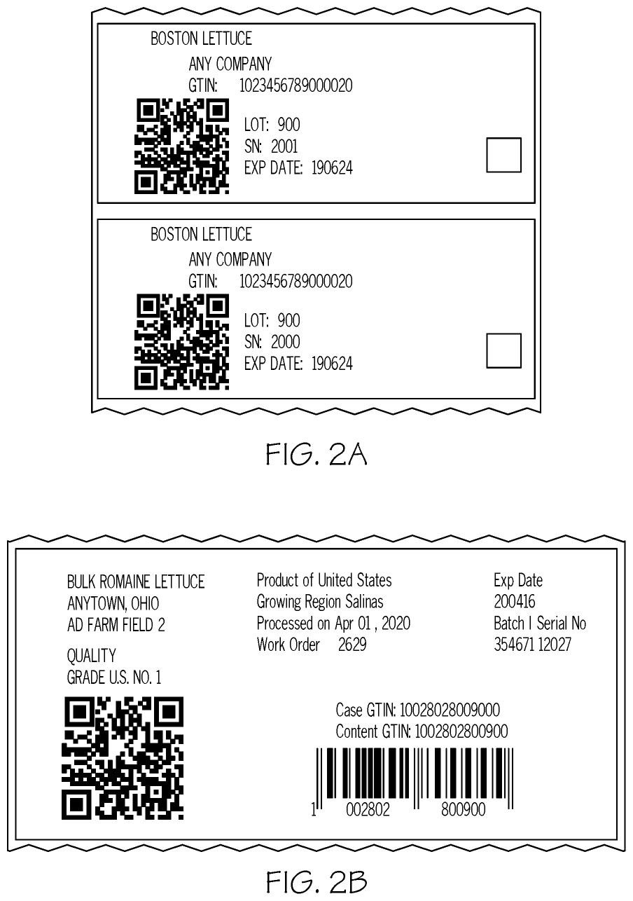

FIG. 2A (relating to a traceability case labels for Boston lettuce) and FIG. 2B provide exemplary outputs where labels are printed with information relating to the product, case, or pallet and include QR codes and/or barcodes. If RFID is included, then the RFID tag will also be encoded with information that is related to the printing information provided on the printed side of the label. It is important to note that although the labels shown in FIGS. 2A and 2B are meant to be applied to a case, they can also be applied to a pallet, shipping container, or rail car, for example.

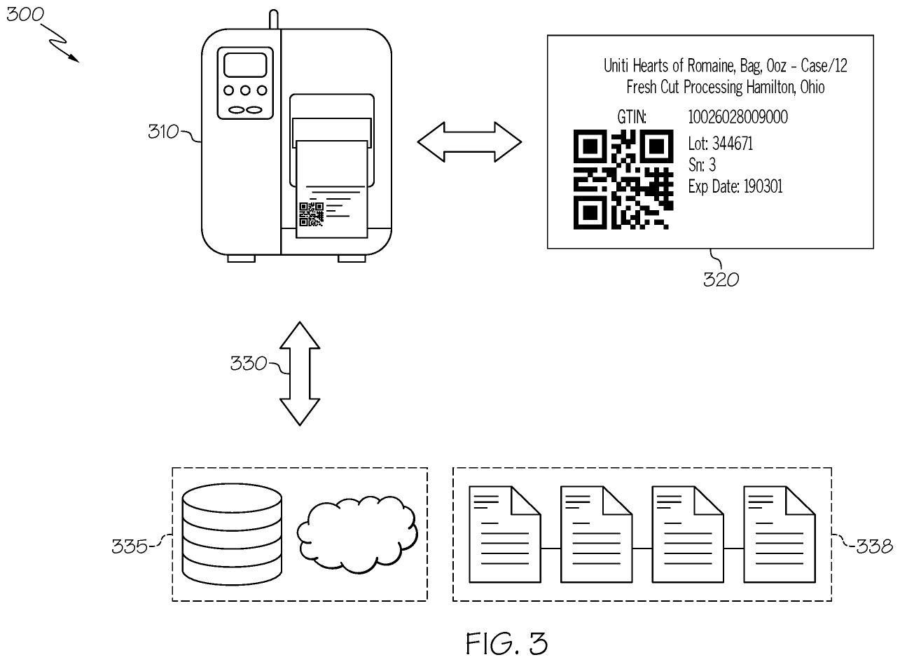

FIG. 3 shows a schematic using the FRESHMARX® system of Avery Dennison Printer Solutions Division of Miamisburg, Ohio to collect the data, print the labels and then provide the related data for retention and later use in a database or cloud-based platform. The system 300 includes a printer/encoder 310, and labels 320 (in the form of automated, serialized QR codes and/or encoded RFID with designated schema (RFID not shown in figure), and data transfer protocol (file, API, and the like) is sent through an interface 330 for transfer of the asset information to a cloud, proprietary database 335 and/or system of ledger entries 338 (like blockchain) at the time of print or print/encode or in a daily batch process. This information is used for commissioning information associated with the packaging (a case containing at least one asset/product/good, a pallet containing at least one case (which contains at least one asset/product/good), or the like), where the commissioning information is sent via EPCIS XML or JSON data. The system captures serialized digital identification (“ID”), device information (location, user, time, date, and the like), and optional item identifiers (including, but not limited to, description, season, lot, expiry, and the like).

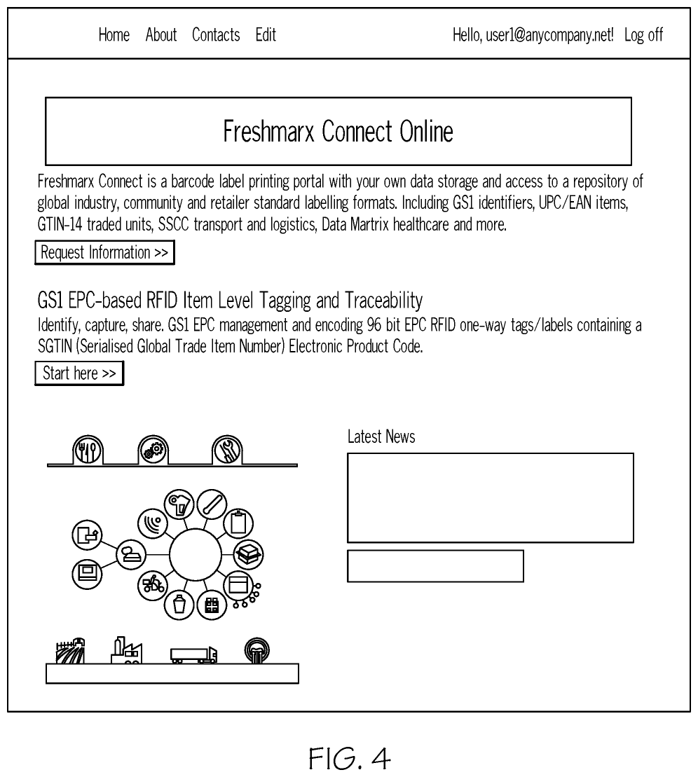

FIG. 4 shows a schematic relating to the data collected and products to be tracked to show the product traceability and to provide transparency to the user of the system or the end user/customer.

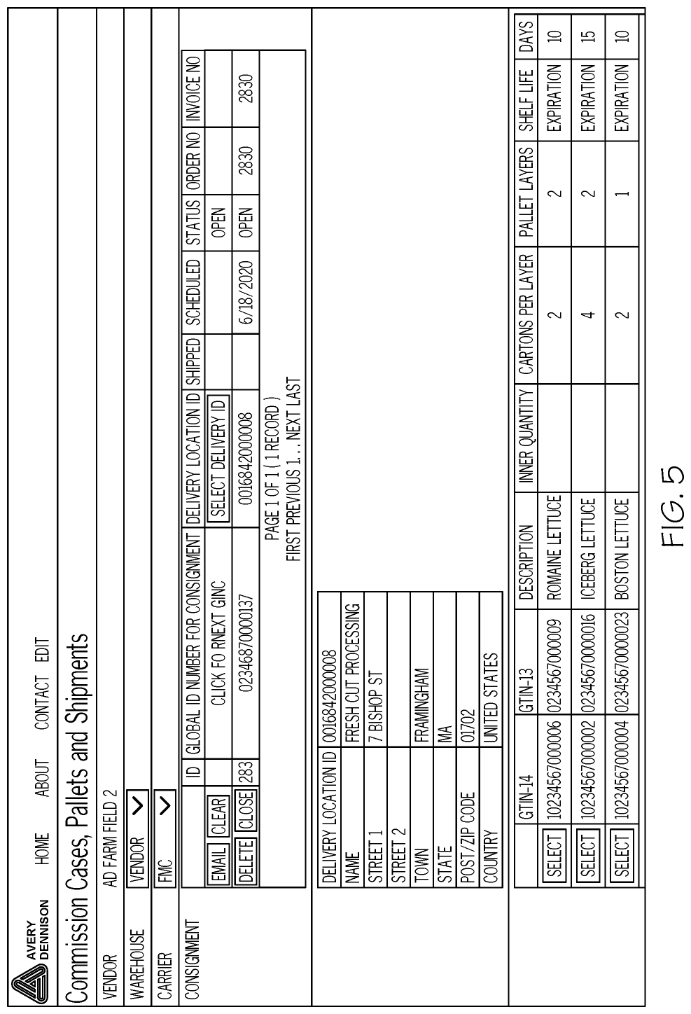

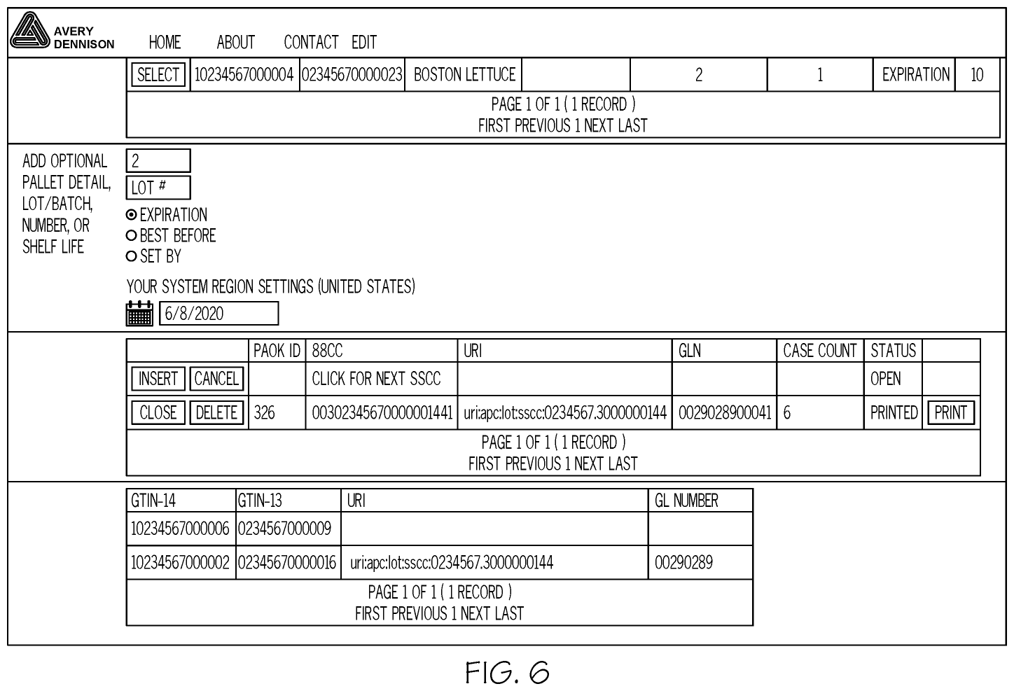

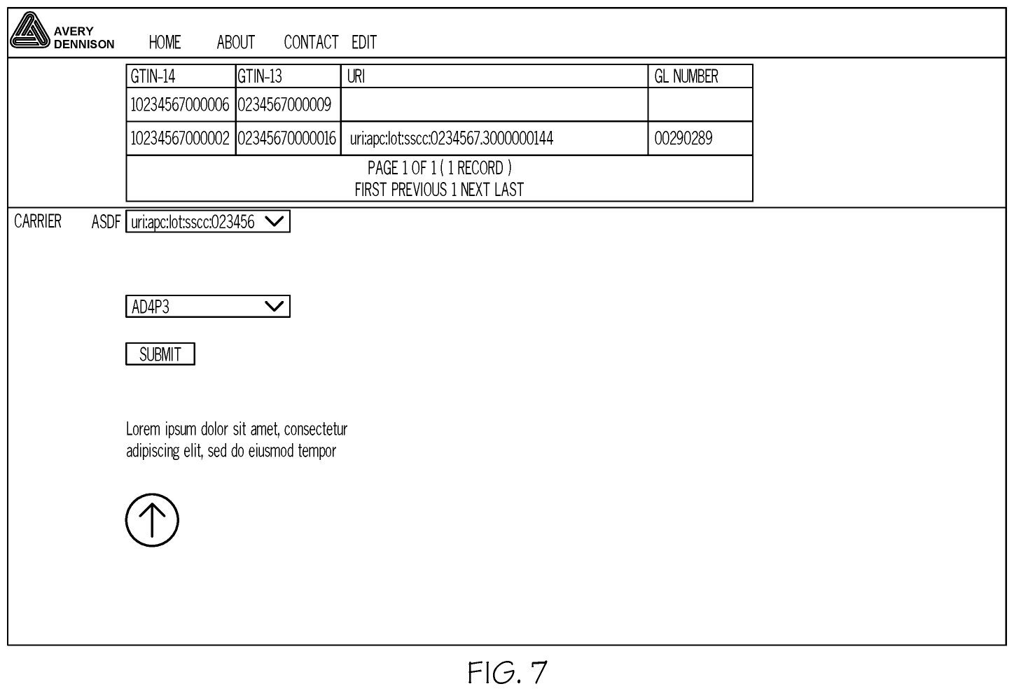

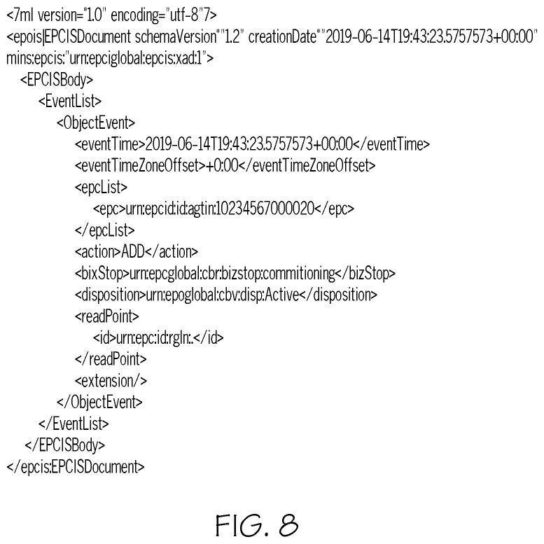

The chart shown in FIG. 8 provides for a commissioning event as depicted in FIGS. 5-7. This commissioning event can be at either the case level or at each level. In either option an associate aggregation event can be created. To either pack into a case and general EPCIS XML or JSON event to aggregate them to the case, and then next to a pallet, shipping container, or rail car.

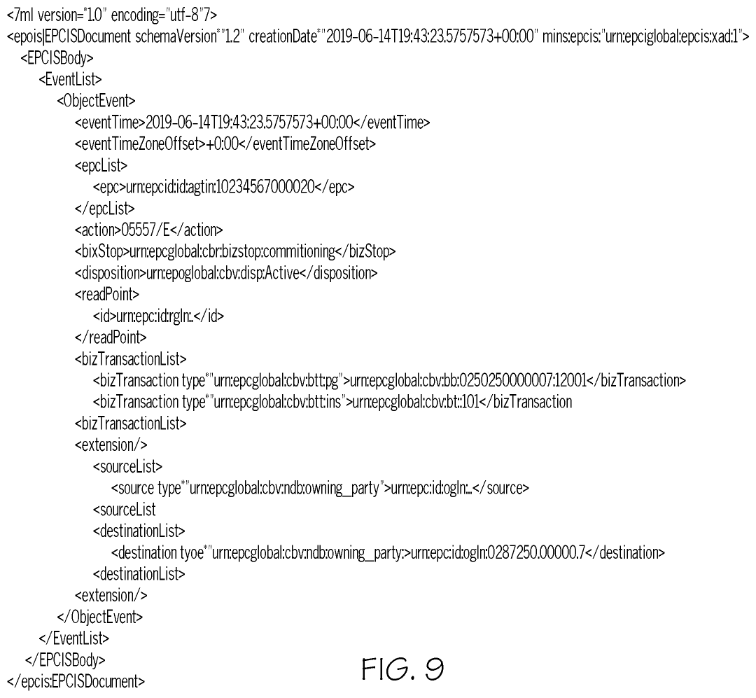

The chart shown in FIG. 9 provides a shipping commissioning event as provided in FIGS. 5-7.

In a food supply chain environment, brands and suppliers need solutions to ensure food traceability and transparency to enable and ensure food safety, fast, accurate recall, error-proof shipping, compliance with sustainability goals, provenance information for consumers, and the like. Automated data capture and supply chain traceability starts by creating and applying, for example, a serialized 2D barcode with a globally unique identifier and/or RFID label at the point of packing. The information contained on the label is seamlessly inserted into distributed storage system such as blockchain, client-server or cloud-based system. This data may include product information, grower information, event time/date (such as when the produce was picked), the lot number, food safety certifications, organic certification, sensor data and the like. Using a distributed storage system to record item and case labeling information enables transparency to all supply chain partners and the consumer, no matter how the food is transformed along the way. Item tracking with information such as lot, location, aggregate item to a case, cases to a pallet, pallets to a transportation vehicle (and so on) helps enable accurate recall, supply chain visibility and provenance transparency for consumers. These labels can be created on-demand or can be pre-printed and applied when needed.

It will thus be seen according to the present invention, a highly advantageous centralized printing and encoding system has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. As described hereinabove, the present subject matter solves many problems associated with previous strategies, methods/processes, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

1. A system for asset traceability and transparency, comprising:
a centralized printing hub having a printer for printing and encoding labels;
at least one asset to be traced;
packaging for the at least one asset;
a machine-readable label for use in tracking and identifying each of the at least one asset;
wherein the machine-readable label is generated by the hub and applied to the packaging; and
wherein the machine-readable label comprises a serialized digital identity associated with each of the at least one asset;
a database connected to the hub for receiving inputs provided to the hub to form commissioning information;
wherein the inputs comprise:
the serialized digital identity associated with each of the at least one asset; and
item instance data associated with each of the at least one asset; and
an interface to exchange the commissioning information associated with the packaging with a distributed storage system;
wherein the commissioning information is sent via an EPCIS XML or JSON data file.

2. The system of claim 1, further comprising:
a device for reading the machine-readable label.

3. The system of claim 2,
wherein the device captures the serialized digital identification for the asset and the item instance data.

4. The system of claim 3,
wherein the item instance data is selected from the group consisting of device location, user, time, date, asset description, packaging description, season, lot, and expiry.

5. The system of claim 1,
wherein the serialized digital identity is encoded on at least one identifier selected from the group consisting a barcode, a radio-frequency identification (RFID) tag (also referred to as a label or inlay), and a quick response (QR) code.

6. The system of claim 1,
wherein the machine-readable label further comprises a global product attribute.

7. The system of claim 1,
wherein the machine-readable label further comprises sensor data associated with the packaging;
wherein the sensor data is at least one parameter selected from the group consisting of weight, temperature, carbon dioxide level, microbial level, and humidity level.

8. The system of claim 1,
wherein the interface is an external programmatic interface or application programming interface.

9. The system of claim 1,
wherein the EPCIS XML or JSON data file comprises EPC data for the machine-readable label.

10. The system of claim 1,
wherein the distributed storage system is an immutable ledger, client server, or cloud-based system.

11. The system of claim 1,
wherein the asset is an item selected from the group consisting of a food product, a pharmaceutical product, a vehicle part, a toy, or a baby product.

12. The system of claim 1,
wherein the packaging is a carton, case, crate, box, or pallet.

13. A method of tracing assets, comprising:
providing a machine-readable label for packaging for at least one asset;
wherein the machine-readable label comprises a serialized digital identity associated with each of the at least one asset; and
extracting the data from the packaging to create an EPCIS XML or JSON data file;
transmitting the EPCIS XML or JSON data file to an external application to commission the asset into a distributed storage system to trace the asset.

14. The method of claim 13,
wherein the machine-readable label further comprises item instance data associated with each of the at least one asset.

15. The method of claim 13,
wherein the machine-readable label further comprises a global product attribute.

16. The method of claim 13,
wherein the machine-readable label further comprises sensor data associated with the packaging;
wherein the sensor data is at least one parameter selected from the group consisting of weight, temperature, carbon dioxide level, microbial level, and humidity level.

17. The method of claim 13,
wherein the distributed storage system is an immutable ledger, client server, or cloud-based system.
